(19) United States
(12) Patent Application Publication
(10) Pub. No.: US 2017/0162082 A1
(43) Pub. Date: Jun. 8, 2017

(54) MySize

(71) Applicant: Travis Kunz, Tequesta, FL (US)

(72) Inventor: Travis Kunz, Tequesta, FL (US)

(21) Appl. No.: 15/369,749

(22) Filed: Dec. 5, 2016

Related U.S. Application Data
(60) Provisional application No. 62/263,649, filed on Dec. 5, 2015.

(51) Int. Cl. G09F 3/00

(52) U.S. Cl. CPC G09F 3/0297; G09F 3/00; G09F 2003/0282

(57) ABSTRACT

The disclosure is directed to a tag for garments that does not provide specific character indication of the size of the garment. The tag of the disclosure has no mention of the size of the clothing anywhere in the garment. The tag can be attached to garments easily and does not wear off after washing. The tag is provided to give a sense of pride to the users. The tag encourages the consumers to go to the stores to select the garments. Such garments without sizes can be bought only after trying them in the stores. The process of selection of the garment is based on the visual estimate of the garment size by the user and not based on the display of the size on the tags of the garments.

This application claims priority to U.S. Provisional Patent Application No. 62/263,649 filed on Dec. 5, 2015, which is incorporated herein in its entirety by reference.

### FIELD

Example embodiments described herein generally relate to a tag for garments and apparel that include a personal insignia in place of a size classification for garments.

### BACKGROUND

U.S. Pat. No. 5,970,641 to Bracken, discusses a strip of flexible material which has indicia repeatedly printed on an outer surface providing sizing or other information about a foldable article to which the strip is attached via an adhesive rear surface. The strip may be placed on the folded article of clothing in a location that is visible to customers despite other similar articles of clothing being stacked on top.

U.S. Pat. No. 3,395,470 to Voice, discusses a garment label used to identify the fabric of a particular garment to which it is attached. The garment label is secured to the garment at a position where an excess of the fabric of the garment is present, such as for example, the bottom of uncuffed men's trousers. An opening in the label allows the excess of fabric to be visible while secured. The excess of the fabric is then cut from the garment, and remains visible through the opening of the label. The label has printed matter on the top and bottom half, relating to the type of garment it is attached to.

U.S. Pat. No. 5,233,380 to Marvy, discusses a film holder packaging strap and an identifying label plate with indicia for identifying the type of film in the film holder. A brand name or code for the type of film is provided on the plate.

U.S. Pat. No. 5,584,103 to Slavin, discusses a reusable plastic banding strap for securing items in a rolled position. The device further provides a surface for placement of indicia to describe the contents of the secured rolled materials.

U.S. Pat. Nos. 1,986,649 and 2,286,181 to Steele, discusses a wrapping band and fastener for securing a folded garment of clothing.

U.S. Pat. No. 2,797,462 to Katzman, discusses a belt buckle upon which is mounted interchangeable, ornamental indicia or letters or insignia. The buckle comprises a base which includes a top portion provided with a bail member for attachment to the end of the belt.

Conventional tagging systems or methods are directed to providing sizing information to the buyers of garments. The prior art includes various garment tags that are made from a soft fabric substrate and can be easily attached to a garment by sewing. In addition to providing the size information to the user, the soft corners and edges of such fabric tags reduce wearer discomfort from pricking and scratching, and can be repeatedly laundered without deterioration. However, repeatingly viewing numerical sizes can cause discomfort or even distress for someone after purchase. As such, for larger sized wearers, a size tag can be an uncomfortable reminder, and a convenient tag without the numerical size could encourage some users to buy a larger sized garment.

Therefore, there is a need in the art to have a size tag that does not disclose the exact size of the wearer and mitigates distress when viewing a garment or article of clothing. It is desirable to have a tag which is attractive in appearance and the wearer can easily relate to without having to view measurement information. Thus, it is desirable that a unique style tag can replace a conventional numerical size tag to solve the aforementioned problems.

### SUMMARY

In view of the foregoing disadvantages inherent in the known types of size tags in the prior art, the present disclosure provides an improved tag for all types of garments. As such, the general purpose of the present disclosure, which will be described subsequently in greater detail, is to provide a new and improved tag for garments.

The inventive aspect described in the specification can be embodied in a tag for garments that provides identification without sizing information, such as by saying “mysize”.

The other inventive aspects can be embodied in a tag that can be attached to garments easily and does not wear off after washing.

Other embodiments of the inventive aspect include providing a tag that promotes a sense of pride and avoids shame to users.

The further embodiments of the inventive aspect can be embodied in providing a tag that encourages consumers to stores to try on garments and apparel without sizing information.

The further embodiments of the inventive aspect can be embodied in providing a tag that encourages consumers to stores to try on garments and apparel without direct sizing information.

Yet other inventive aspects can be embodied in providing a process of selection of a garment based on a viewing of one or more users and not on the size display on tags of garments.

The inventive aspect described in the specification can be embodied in providing a tag for garments which may be easily and efficiently manufactured and marketed.

The other inventive aspects can be embodied in a tag for garments which is of a durable and reliable construction.

Other aspects of the present disclosure will become apparent from time to time throughout the specification as hereinafter related.

There has thus been outlined, rather broadly, the more important features of the disclosure in order that the detailed description thereof that follows may be better understood and in order that the present contribution to the art may be better appreciated.

Numerous objects, features and advantages of the present disclosure will be readily apparent to those of ordinary skill in the art upon a reading of the following detailed description of presently preferred, but nonetheless illustrative, embodiments of the present disclosure when taken in conjunction with the accompanying drawings. The disclosure is capable of other embodiments and of being practiced and carried out in various ways. Also, it is to be understood that the phraseology and terminology employed herein are for the purpose of descriptions and should not be regarded as limiting.

### BRIEF DESCRIPTION OF THE DRAWINGS

The example embodiments of the inventive concept will be better understood from the following brief description taken in conjunction with the accompanying drawings. The drawing FIGS. 1-3 represent non-limiting, example embodiments:

FIG. 1 is a front view of the tag on a pair of shorts, in accordance with an example embodiment.

FIG. 2 is a front view of the tag according in accordance with an example embodiment.

FIG. 3 is a front view of the tag on a pair of shorts with label of the brand placed above the tag of the disclosure, in accordance with an example embodiment.

### DETAILED DESCRIPTION OF THE DISCLOSURE

In the following description, reference is made to the accompanying drawings which form a part hereof, and in which is shown by way of illustration specific embodiments in which the inventive concept may be practiced. These embodiments are described in sufficient detail to enable those skilled in the art to practice the inventive concept, and it is to be understood that the embodiments may be combined, or that other embodiments may be utilized and that structural and logical changes may be made without departing from the spirit and scope of the present inventive concept. The following description is, therefore, not to be taken in a limiting sense.

Example embodiments of the inventive concepts may be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, some dimensions are exaggerated for clarity.

The terminology used herein is for the purpose of describing particular embodiments only and is not intended to be limiting of example embodiments of the inventive concepts. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments of the inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Referring to the disclosure now in more detail, the disclosure is directed to a tag for garments that would only say “mysize”. The tag of the disclosure has no specific mention of the size of the clothing anywhere on the garment and the tag can be attached to garments easily and does not wear off after washing. The tag of the disclosure or the “mysize” tag gives a sense of pride to users. The tag that pushes the consumers to the stores as garments without sizes can be bought only after trying them in stores. The process of selection of the garment is based on sight of the user and not on the size display on the tags of the garments.

The purpose of the disclosure is to provide a user with an attractive tag that has no mention of the size anywhere on the garment and simply states “mysize”. This section summarizes some aspects of the present disclosure and briefly introduces some preferred embodiments. Simplifications or omissions in this section as well as in the abstract or the title of this description may be made to avoid obscuring the purpose of this section, the abstract and the title. Such simplifications or omissions are not intended to limit the scope of the present disclosure nor imply any limitations.

FIG. 1 is a front view of the tag on a pair of shorts, in accordance with an example embodiment. FIG. 1 shows a simple tag 10 without any reference to a numerical size or other specific sizing information. The tag ensures users are not intimidated by sizing information and the sizing may be based on trying on the actual garment or apparel.

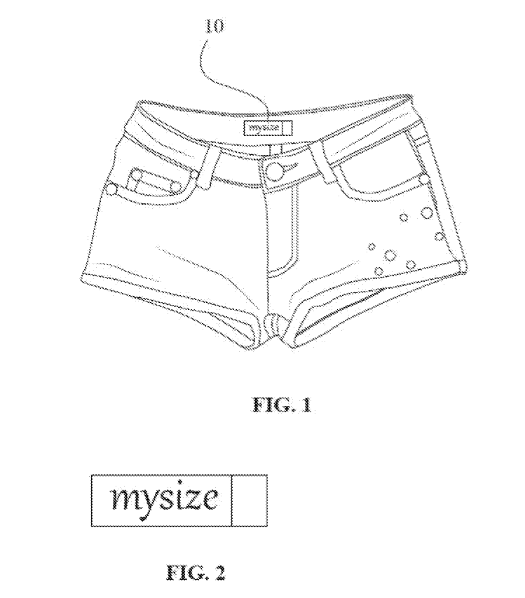

FIG. 2 is a front view of the tag in accordance with an example embodiment. FIG. 2 shows a simple identifier for a user in which the tag 10 written in the Gabriola small font making it more attractive to the user/wearer.

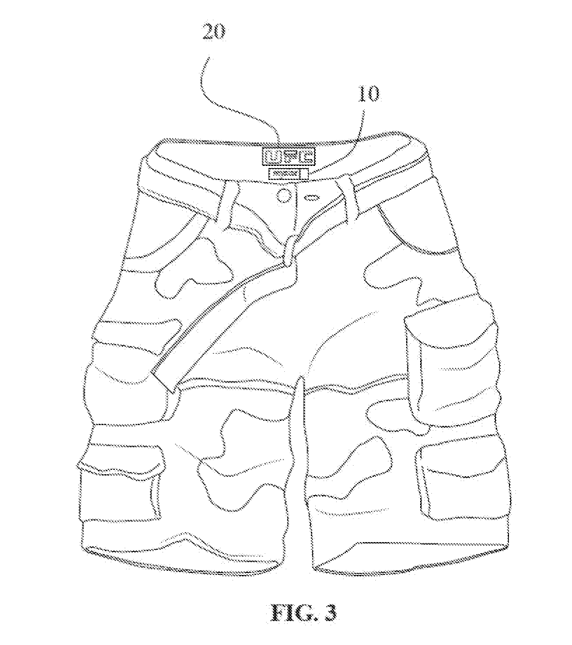

FIG. 3 is a front view of the tag on a pair of shorts with label of the brand placed above the tag of the disclosure, in accordance with an example embodiment. FIG. 3 shows a tag on a pair of shorts with label of the brand 20 placed above the tag of the disclosure. The size of the tag 10 can vary according to the type of garment and actual size.

In one embodiment, a selection process of the garment is based on sight of the user and not on the size display on the tags of the garments. The user is encouraged to visit a store with the relevant garments without size tags. The garments are encouraged to be purchased only after been tried on and/or fitted for a user. Thus, the sale of the garment may also encourage further shopping due to in person visits. In one embodiment, the purchasing process includes the wearer selecting the garment on rough estimate of size based on a viewing of the correct fit and a trial of the garment in a fitting room of the store.

In another example embodiment, tag 10 and brand name label 20 are provided together such that the size of the tag 10 may be compared with a size of the brand name label 20 so that the size information of the garment may be estimated for a user without specifically indicating the size of the garment.

In another example embodiment, tag 10 and brand name label 20 are provided together such that the width of the tag 10 may be compared with a width of the brand name label 20 so that the width of the garment may be estimated for a user without specifically indicating the width of the garment.

In another example embodiment, tag 10 and brand name label 20 are provided together such that the length of the tag 10 may be compared with a length of the brand name label 20 so that the length of the garment may be estimated for a user without specifically indicating the length of the garment.

In a further example embodiment, the garment tag is only readable by a smart phone to indicate the garment size. In yet further example embodiment, the smart device displays the garment size only for a certain amount of time, i.e., after displaying the size of the garment for a few seconds, the size information disappears in the smart device. Accordingly, the size of the garment is displayed as a disappearing message in the smart device. Thus, the size of the garment may not be available anywhere in human readable indicia or character.

In another example embodiment, the garment includes a tag that comprises only a machine readable indicia to indicate the size of the garment.

In one embodiment, the tag may not be limited to any particular garment or apparel including shorts and may be successfully used for garments of all types and sizes including pants, trousers, shirts, or other garments and apparel.

Although the disclosure uses Gabriola font small to write “mysize” on the tag, however it is not limited to use only Gabriola font for the purpose of making the tag as described in the disclosure.

The disclosure is not limited to use only for women garments for the purpose of attaching the tag as described in the disclosure it can be used for any garments.

A unique tag for garments having been described, all such foreseeable modifications, adaptations, substitutions of equivalents, mathematical possibilities of combinations of parts, pluralities of parts, applications and forms thereof as described by the following claims and not precluded by prior art are included in this disclosure.

Plural instances may be provided for components, operations or structures described herein as a single instance. Finally, boundaries between various components are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. A tag for a garment, wherein
the tag comprises written characters that do not indicate a size of the garment.

2. The tag as claimed in claim 1, wherein the written characters include “mysize”.

3. The tag as claimed in claim 1, wherein said the tag is written in gabriola small font.

4. A tag as claimed in claim 1, wherein the tag is used on the garment for female users.

5. A tag as claimed in claim 1, wherein the tag is used on garment for male users.

6. A tag as claimed in claim 1, wherein the tag is configured to be used on the garment of all types.

7. A tag as claimed in claim 1, wherein a relative size of the tag with respect to a size of the brand label provides an estimate of the size of the garment.

8. A garment comprising:
a brand label associated with the garment; and
a tag including written characters that do not indicate the size of the garment, wherein a relative size of the tag with respect to a size of the brand label provides an estimate of the size of the garment.

9. The garment of claim 8, wherein the garment does not provide any character indication of the size of the garment.

10. The garment of claim 8, wherein when the size of the tag is smaller than the size of the brand label and the tag represents the garment of small size.

11. The garment of claim 8, wherein when the size of the tag is larger than the size of the brand label and the tag represents the garment of large size.

12. The garment of claim 8, wherein when the size of the tag is equal to the size of the brand label and the tag represents the garment of medium size.

13. The garment of claim 8, wherein the tag includes color codes for further indication of the associated size of the garment.

14. The garment of claim 8, wherein the tag comprises only machine-readable indicia to indicate the garment size.

15. The garment of claim 8, wherein the tag is only readable by a smart phone to indicate the garment size.
